(19) United States
(12) Patent Application Publication
(10) Pub. No.: US 2008/0186154 A1
(43) Pub. Date: Aug. 7, 2008

(54) Method and Device for Driver Support

(75) Inventor: Karsten Haug, Stuttgart (DE)

Correspondence Address: KENYON & KENYON LLP, ONE BROADWAY, NEW YORK, NY, 10004, US

(73) Assignee: ROBERT BOSCH GMBH, STUTTGART (DE)

(21) Appl. No.: 11/664,377

(22) PCT Filed: Aug. 19, 2005
(86) PCT No.: PCT/EP05/54108

§ 371 Date: Mar. 30, 2007

(30) Foreign Application Priority Data
Oct. 1, 2004 (DE) 10-2004-048-010.9

(51) Int. Cl. B60Q 1/00

(52) U.S. Cl. 340/435

(57) ABSTRACT

A method and a device for driver support are proposed in which the warning signal produced upon departure from the lane is dependent on the lane used and/or is dependent on the side at which the departure takes place and/or is dependent on the driver's behavior.

### FIELD OF THE INVENTION

The present invention relates to a method and a device for driver support.

### BACKGROUND INFORMATION

methods and devices for driver support, known as driver assistance systems, have been described in various forms. One example of such a driver assistance system is a lane departure warning system, which warns the driver when the vehicle departs from the lane or threatens to depart from the lane. An example of such a lane departure warning system is described in European Patent No. EP 10 74 430 A1. Here, on the basis of an image provided by a forward-directed video camera, the position of the vehicle in the lane is determined and a warning message is emitted upon departure, or threatened departure, from the lane.

German Patent Application DE 102 10 130 A1 describes a lane departure warning system in which a state of attentiveness of the driver, determined on the basis of steering, braking, or gas pedal movements, is taken into account in the warning. The less attentive the driver is assessed to be, the earlier the warning takes place.

### SUMMARY

Through a warning strategy that is designed dependent on the lane in use and/or lane side in use and/or that is tailored to the individual driver, false warnings may be avoided and the degree of acceptance of the lane departure warning system is increased. This may be achieved in that a warning upon departure from the lane or threatened departure from the lane takes place if the driver's behavior deviates significantly from the standard driving behavior of this driver, or in that the driving situation, in particular the standard pattern of behavior in various lanes of a multi-lane roadway, is taken into account with regard to its potential for danger.

It may be particularly advantageous if the driver-specific dependence of the warning strategy is adapted to changes in the driver's driving behavior, in the context of a learning algorithm.

Thus, advantageously, the normal driving state of various drivers may be taken into account in the training of the warning strategy. It may be taken into account that many drivers always drive in the center of the lane, while others, for example on the right lane of a highway, purposely drive far to the right, and consciously accept contact with the right lane marking. The same can be true for the left lane marking when driving on the left lane of a multi-lane roadway having separated directions of travel (e.g., a highway or highway-type construction of the road). Here as well, many drivers even consciously accept to some extent a crossing over of the edge strip by a few centimeters. Analogous behavior can be observed during driving on center lanes; here, contact with the lane marking is not tolerated, so that in this case a warning has to be issued. Such driving-situation-dependent and/or driver-specific situations are taken into account by the procedure described below in the training of the warning strategy; in this way, an optimal adaptation of the warning strategy to the driver and/or to the driving situation is achieved.

### BRIEF DESCRIPTION OF THE DRAWINGS

The present invention is explained in more detail below on the basis of example embodiments shown in the figures.

FIG. 1 shows an overview of a processing unit that includes a lane departure warning system.

FIG. 2 is a flow diagram of an example embodiment for training a warning strategy dependent on the driving situation, in particular the lane used, and/or on the driver's behavior.

FIG. 3 shows a flow diagram of an exemplary embodiment of a learning algorithm for determining a driver-specific training of the warning strategy of the lane departure warning system.

### DETAILED DESCRIPTION OF EXAMPLE EMBODIMENTS

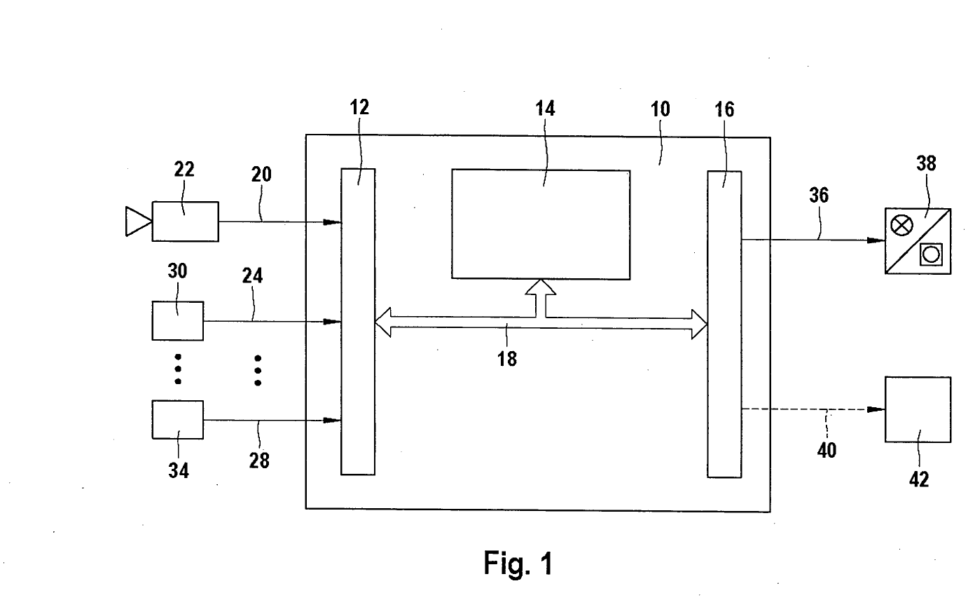

FIG. 1 shows a device that is part of a system for driver support (e.g., for warning and/or for controlling an actuating element for lateral guidance of the vehicle upon departure or threatened departure from the lane). Depicted is a control or evaluation unit 10 that has at least one input circuit 12, a microcomputer 14, and an output circuit 16. These elements are connected to a bus system 18 for mutual data exchange. Input circuit 12 is supplied with input lines from various measurement devices, via which measurement signals or measurement information can be communicated. A first input line 20 connects input circuit 12 to an image sensor system 22 (mono or stereo camera) that records the scene in front of the vehicle.

Corresponding image data are transmitted via input line 20. In addition, input lines 24 to 26 are provided that connect input circuit 12 to measurement devices 30 to 34. These measurement devices include, for example, devices for measuring the speed of the vehicle, acquiring the steering angle and/or the yaw rate, acquiring a quantity that represents the driver's desired acceleration, for example, the degree to which the driver actuates the gas pedal, acquiring the speed and/or the acceleration of the vehicle, and acquiring additional operating quantities of the vehicle that are significant in connection with the procedure described below. Via output circuit 16 and output line 36, at least one warning device 38 is controlled, for example a warning lamp and/or a loudspeaker for an acoustic warning and/or for speech output and/or a display for displaying an image and/or an actuating element for a haptic indication with the aid of which the driver is informed of the (threatened) departure from the lane. In addition, or alternatively, in some specific example embodiments it is provided to control, via output circuit 16 and an output line 40, an actuating system 42 that automatically guides the vehicle back into the lane (lateral guidance), for example by intervening in the steering system or the brake system of the vehicle, thus preventing departure from the lane.

Using image analysis methods, in the exemplary embodiment of the lane departure warning system image data supplied by the image sensor system concerning the scene in front of the vehicle are used to determine lane data that represent the course and the size of the lane and of all adjacent lanes, so that the complete lane situation (number of lanes, separation from oncoming traffic, etc.) of the roadway is known. Thus, for example, the lane edge markings (left and/or right lane edge) are acquired, and the course of the respective lane edge is approximated, for example as a polynomial (third-order power function). In addition, the course of the vehicle's track, e.g., for the right and/or left wheel, is calculated from vehicle geometric quantities, the current and possibly past quantities of vehicle speed, steering angle or yaw rate, etc., and is also represented as a polynomial. From these data, additional lane data are calculated, for example the lateral distance between the lane marking and the track of the vehicle (right side to right edge, left side to left edge), the curvature of the track, and/or the angle between the track and the lane marking (right track to right edge, left track to left edge) on the basis of tangent comparisons. From these data, in an embodiment the expected time until line crossing may also be calculated. In the preferred exemplary embodiment, the warning takes place upon exceeding of a predetermined lateral distance, or upon undershooting of a predetermined time value.

A first aspect of the present invention is that the warning strategy of a lane departure warning system is dependent on the lane in which the vehicle is situated. The warning strategy thus takes into account the lane of a roadway having a plurality of lanes in one direction of travel (e.g., a highway) in which the vehicle is situated. This is determined using video-based lane detection, which derives the position of the vehicle in one of a plurality of recognized lanes. Here a distinction is made between edge lanes (left and right) and center lanes. Moreover, in one example embodiment, a distinction is made between the left and the right edge of the lane. In this way, for each lane, or for each lane edge, a maximum permissible distance measure Xmax is determined, relative, for example, to the inner side of the lane marking as a warning threshold for recognizing a crossing of the corresponding lane edge. The permissible distance measure can thus be differently selected (i.e., can assume a different value) for each lane, and if necessary for each side of a lane. Depending on the embodiment, the distance measures can also in part or in whole have the same value.

When traveling on a rural road or some other one-lane roadway, a distinction is also made between the left and the right lane marking. Thus, a second aspect of the present invention, in addition to or alternative to the lane-specific warning strategy, is a warning strategy that distinguishes the left and the right lane edge from one another and that predetermines distance values that can be differently selected for each lane edge.

Here, the determined distance value (warning threshold) is determined dependent on the potential danger. For the right edge of the right lane, a first value (lateral distance to the lane edge marking) is determined, e.g., 40 cm, and for the left edge of the left lane another value, e.g., 30 cm, is determined, while for the center lanes 0 cm, or even negative values (i.e., the warning location is situated within the lane), can be determined. Alternatively to the geometrical distance measures as warning thresholds, maximum time threshold values before departure from the lane (Tmax) can be determined (time to line crossing). In the following, in connection with the warning threshold of the lane departure warning system, the term “distance measure” refers both to the geometrical distance measure (lateral distance of the vehicle from the lane) and also to the temporal distance measure.

Another advantage is that the warning strategy is adapted in driver-specific fashion, i.e., dependent on the driver's behavior or on the driving style of the driver. The maximum distance values referred to above are used only if the driver's driving style permits the inference that he is making use of these threshold values, which are intentionally set to be low. For drivers who drive in the center of the lane in a very disciplined fashion, it is appropriate to reduce these threshold values towards zero, or even to provide negative values. Thus, an individual value Xmax_individuell is determined individually for each driver, preferably for each lane and preferably for each lane strip. In a preferred specific embodiment, this value is obtained on the basis of a self-learning algorithm.

In the preferred exemplary embodiment, the following learning strategy is used. Learning takes place only if the driver has been assessed as attentive. For this purpose, the above-indicated criteria for rating the driver as attentive or inattentive are used. Depending on the embodiment, other parameters may also be used, for example an observation of the driver (eyelid behavior, head position, etc.). During the learning phase, the driver's driving behavior in the lane is observed. In the simplest case, the learning strategy consists in the storage of the maximum value by which a lane is crossed as an individual distance measure. However, this takes place only if the predetermined maximum value Xmax is not exceeded. Advantageously, after a predetermined correction time the individual distance value is incrementally reduced, so that a one-time unintentional slip will not have an arbitrarily long effect.

An alternative to the depicted learning algorithm is to calculate the standard deviation of the current measurement value from the center of the lane, and, dependent on this standard deviation, to calculate the value of the individual distance measure, e.g., by determining an average standard deviation over a certain period of time, and to determine the value of the individual distance measure dependent on this mean value. A warning is issued to the driver upon exceeding of the currently valid individual distance measure value.

In the simplest case, the depicted learning cycle begins with the beginning of the activation of the lane departure warning system, and ends when the system is deactivated. In an alternative embodiment, the learning cycle is extended to cover the entire driving cycle of a driver. In this case, the learning cycle is activated when the driver gets into the vehicle (recognition of the opening of the driver's door, or occupation of the driver's seat, etc.), and ends when the driver gets out of the vehicle. Recognition of occupation of the driver's seat ensures that there is not a change of drivers during the driving cycle.

In another embodiment, in the determination of the individual distance measure value the current lane course is also made use of, so that the width of the lanes and/or their curvatures are also taken into account. This means that in the case of wide lanes the individual distance measure value is reduced on the basis of the learned value or on the basis of a driver-specific value determined in some other manner. This means that the value is modified in the direction of smaller distances to the edge. In the case of narrow lanes, or in the case of curvatures, the value is reduced for the edge on the inside of the curve, and is increased for the edge on the outside of the curve.

In another embodiment, for the reduction of the driver-specific value the current vehicle speed is used. At higher speeds, as a rule a higher degree of adherence to the lane is required. This means that at higher speeds the warning algorithm sets narrower limits on the driver's adherence to the lane than is the case at lower speeds. In other words, at higher speeds the individual value is increased, so that the warning takes place earlier than at lower speeds. This in turn means that a very tired driver who is no longer driving carefully will be swayed to lower speeds by more frequent warnings.

In another specific embodiment, the learning behavior of the individual value changes with the duration of the trip. Thus, at the beginning of the trip a stronger modification of the individual value takes place, compared to the modification after several hours of travel. This takes into account that a training of the parameters preferably takes place while the driver is still well-rested, while a more negligent driving style should not be used to improve the warning parameters. A stronger modification of the value means here that the speed of change of the value is greater.

In addition, in an embodiment a distinction is made between broken lane lines and solid lane lines. This means that the distance value is selected dependent not only on the lane and/or the side of the lane, but, in addition or alternatively, is also selected dependent on the type of lane line. In particular, it can be provided that the distance value is selected such that for broken lines a warning is issued later than for solid lines.

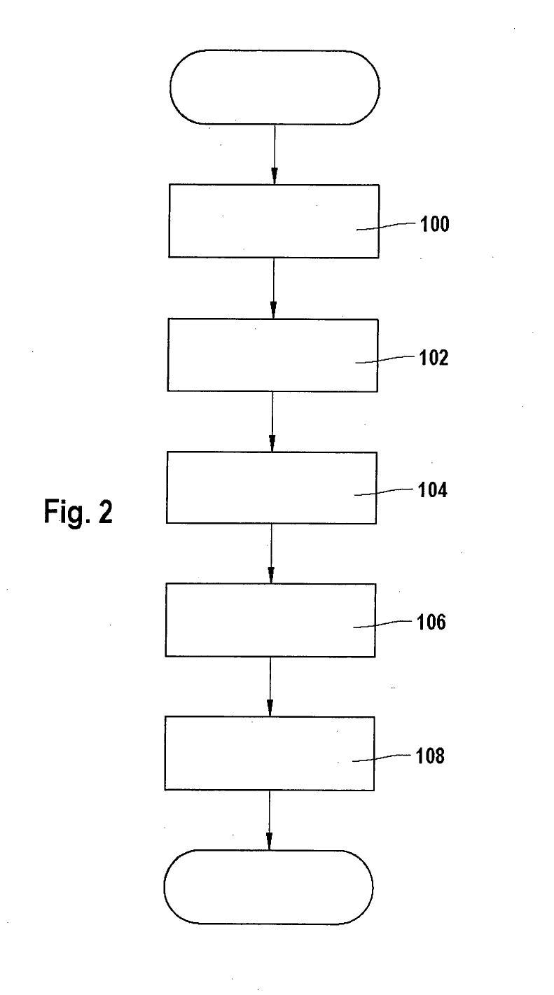

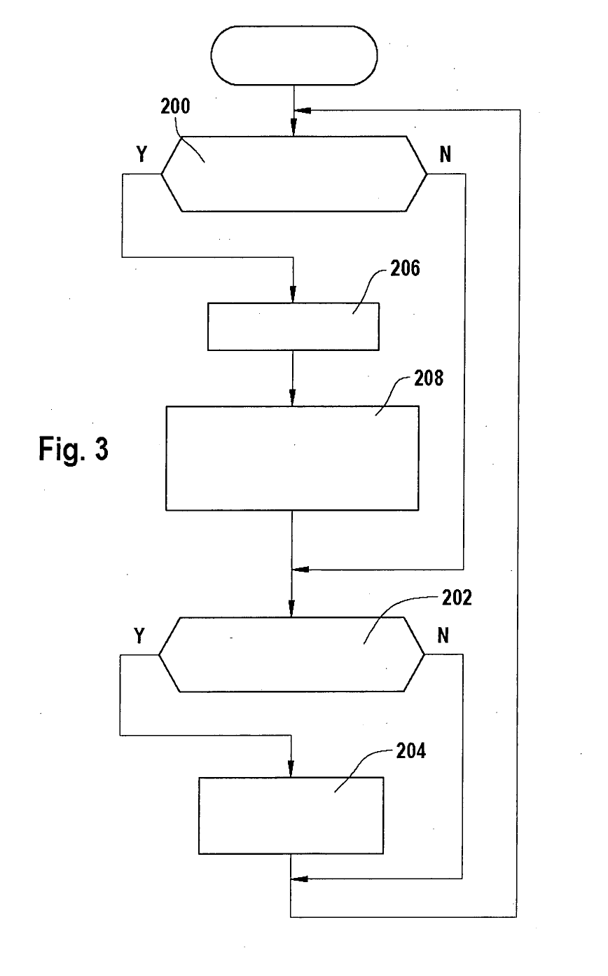

The realization of the above-described procedure takes place in the context of a program of the microcomputer of the processing unit. Examples of such programs are shown on the basis of the flow diagrams of FIGS. 2 and 3. The depicted programs will run at predetermined time intervals.

FIG. 2 shows a flow diagram that indicates the determination of distance values (geometrical or temporal) for lanes and/or lane sides and/or in a driver-specific manner.

The depicted program is executed cyclically when the lane departure warning system is active. In first step 100, it is determined in which lane the vehicle is situated. This takes place on the basis of an analysis of the image of the area in front of the vehicle, recorded by a video camera, possibly taking navigation data into account. In the case of a multi-lane roadway (this information can be derived from the camera image or from data of a navigation system), it is determined in which lane the vehicle is situated (left, center, right, etc.). In the following step 102, dependent on the result of step 100 the distance measure Xmax is determined. For this purpose, in the preferred exemplary embodiment, a table is provided in which values are specified dependent on the lane and possibly on the roadway edge under consideration. In the case of a multi-lane roadway (in one direction of travel), values are thus provided for each lane, and possibly for each roadway edge. In the case of a one-lane roadway (in one direction of travel), one value is determined for the left edge and one value is determined for the right edge. In addition, in one or both cases the type of edge marking can also be taken into account, in that different values are specified for broken lines and for solid lines. Dependent on the driving situation determined in step 100, in step 102 the corresponding boundary values for the current vehicle lane, Xmaxleft, Xmaxright, are thus selected. Subsequently, in step 104 the driver-specific distance value valid for the current lane, which can also be different for the two sides of the lane, is read in (Xmax_individuell_left, right). In the subsequent step 106, the value relevant for the respective side of the lane is then determined on the basis of the values determined in step 102 or the values read in in step 104. In the preferred exemplary embodiment, the smaller of these values is selected for each side of the lane. In step 108, these values are then supplied to the warning algorithm, which then warns the driver in the manner described above when a departure from the lane threatens or has taken place.

It is to be noted that X_max has a positive value, oriented inward from the lane line. This means that the warning boundary moves in the direction of the lane line as it becomes smaller.

FIG. 3 shows a flow diagram that depicts a preferred example embodiment of the learning algorithm for the driver-specific value. Here as well, the depicted program is executed cyclically.

With the activation of the lane departure warning system, or with the beginning of the driving cycle of a driver (recognition of occupation of driver's seat, etc.), the program depicted in FIG. 3 is started. At this time, a counter is activated and a starting value is specified for the individual distance measure values. In the first step 200, it is checked whether the driver is to be assessed as attentive. This takes place on the basis of the quantities named above, which are evaluated in such a way that the driver can be classified as “attentive” or “inattentive.” If the driver has been classified as inattentive, in step 202 it is checked whether a counter has elapsed. If this is not the case, the program is repeated. Otherwise, in step 204 the individual distance measure values are incremented (so that the warning takes place earlier), the counter is set to zero, and the program starts again.

After step 204, the program continues with step 200 and the check of the extent to which the driver is attentive or inattentive. If the driver is attentive, in step 206 the currently measured distance measure value (geometrical or temporal) for the left and right side of the lane is read in. The distance measure value is determined in the manner described above, on the basis of the course of the edge markings and the current course of the vehicle. Subsequently, in step 208 the stored distance value is modified if necessary, preferably by forming the minimum value (or a weighted mean value) from the currently measured value and the stored value. Thus, in step 208 for the left and right edge of the current lane an individual distance value is present that can be corrected or further processed as necessary (cornering, speed, lane width, etc.), and made available to the lane departure warning system according to FIG. 2.

After step 208, the counter is checked (step 202), which, upon the elapsing of a predetermined time period, leads to an incrementing (step 204) of the stored individual distance value to the left and to the right. This effectively corrects outliers in the driver's driving behavior, preventing such outliers from having a lasting influence on the functionality of the lane departure warning system.

1-10. (canceled)

11. A method for support of a driver of a vehicle, comprising:
producing a warning signal when the vehicle departs from a current lane or threatens to depart from the current lane;
wherein the producing of the warning signal is a function of at least one of: i) a lane that the vehicle is using, ii) a side of the lane that the vehicle is using, and iii) a behavior or driving style of the driver.

12. The method as recited in claim 11, further comprising:
specifying a distance value, the warning signal being produced upon an exceeding of a specified distance value.

13. The method as recited in claim 12, wherein the distance value is one of geometrical or temporal.

14. The method as recited in claim 13, wherein the distance value is a lateral distance to a lane edge marking.

15. The method as recited in claim 13, wherein the distance value is a time until crossing of a roadway edge marking.

16. The method as recited in claim 13, wherein a distance value is specified for at least one of: i) each lane of a multi-lane roadway in one direction of travel, and ii) each lane edge (left, right).

17. The method as recited in claim 12, wherein the distance value is specified as a function of a danger potential.

18. The method as recited in claim 12, wherein the distance value is a function of a speed of the vehicle.

19. The method as recited in claim 12, wherein the distance value is a driver-specific distance value, the driver-specific distance value being defined as a function of the driver's behavior or driving style.

20. The method as recited in claim 12, wherein the distance value is a driver-specific distance value, the driver-specific distance value being modified in the context of a learning process.

21. The method as recited in claim 12, wherein the distance value is a driver-specific distance value, the driver-specific distance value being a function of at least one of a speed of the vehicle, and a duration of travel.

22. A device for support of a driver of a vehicle, comprising:
a processing unit that produces a warning signal when the vehicle one of: i) departs from a lane, or ii) threatens to depart from a lane,
wherein the processing unit is adapted in such a way that the warning signal is produced as a function of the at least one of: i) a lane being used, in the case of a multi-lane roadway in one direction, ii) a side of the lane, and iii) the driver's behavior or driver's driving style.
